(19) United States
(12) Patent Application Publication
(10) Pub. No.: US 2014/0198969 A1
(43) Pub. Date: Jul. 17, 2014

(54) Device and Method for Contribution Accounting

(71) Applicant: Kenya McRae, Huntsville, AL (US)

(72) Inventor: Kenya McRae, Huntsville, AL (US)

(21) Appl. No.: 13/849,006

(22) Filed: Mar. 22, 2013

Related U.S. Application Data
(60) Provisional application No. 61/753,353, filed on Jan. 16, 2013.
(60) Provisional application No. 61/794,780, filed on Mar. 15, 2013.

(51) Int. Cl. G06Q 40/00

(52) U.S. Cl. CPC G06Q 40/10
USPC 382/138

(57) ABSTRACT

A system or apparatus employing a multi-functional scanner and software running upon a computing device for capturing payment or donation data from indicia positioned upon scanned documents tendered with donations or payments and optionally, subsequent total compilation and entry of thereof directly into accounting software.

This Application Claims Priority to U.S. Provisional Patent Application Ser. No. 61/753,353 filed on Jan. 16, 2013 and U.S. Provisional Patent Application Ser. No. 61/794,780 filed on Mar. 15, 2013, included herein in their entirety by this reference thereto.

### BACKGROUND OF THE INVENTION

1. Field of the Invention

The present invention relates generally to method and apparatus for tracking charitable contributions. More particularly, the invention relates to a computer enabled system and method employing hardware and software adapted to the task of capturing donor and donation data from a plurality of different pre-printed and handwritten documents such as contribution envelopes and pages of various sizes having indicia thereon concerning monetary contributions, for compilation and entry directly into accounting software. Employment of the system significantly enhances the speed and accuracy of the entire process from that of conventional human reading and input systems. This enhanced speed and accuracy is extremely important due to the high potential of audits of both contributors and charitable entities by multiple state and federal tax agencies.

2. Prior Art

In the United States and many industrialized nations, many non-profit organizations, such as churches, ministries, youth groups and the like, rely on contributions from generous donors to fund the building and running of facilities, pay employees, and for special projects, programs, and special events. Such contributions can be donated through many methods such as fund raising events, or simply through individual offerings given by individual organization donors and participants. In many cases, the contributing donors to the individual religious or charitable organization are given the opportunity to submit contributions by filling out information by hand on contribution documents. Such contribution documents may be credit card authorizations or simple sealable envelopes for placing of donations therein. In the case of envelopes, the donor's identification and amount donated are frequently placed on the exterior of the envelope. For example, during church services, donors attending a service frequently will place donations into a donor envelope which is deposited with an usher or a drop box. Donor and donation information is written by the donor on a donation slip placed within the envelope, or by writing on the exterior of an envelope.

Employing such an envelope or similar forms having positions for donor handwriting, the donor can place cash, credit card information or checks. Donors may also provide the church or charitable cause bank account information along with a donation amount as needed for a one-time debit of the account for a single donation, weekly donation, or monthly recurring donation. Conventionally, such donor documents may be in the form of a hard-copy document including a handout, invoice, voucher, flyer, checks, newsletter, mailer, pre-printed envelope, or the like. Such donor documents, when provided by the church or charity, will conventionally print organization information and input areas for handwritten donor indicia which includes blank fields positioned for the donor to enter handwriting or printing therein. Of course, an overriding intent of such document provision by churches and charities is for donor convenience and thus pre-printed donation documents will generally bear sufficient indicia, adjacent to easy to fill-in areas, to allow the donor to use a pen or pencil and thereby provide the organization with donation amounts and donor identification information with minimal inconvenience on the part of the donor.

Typical information the donor provides is that information which will allow the receiving charitable institution to document the individual, and monthly, quarterly, or annual aggregate total of respective donor donations, to allow the charitable institution to document the donor's donation for tax purposes, as well the charitable institution's donor tracking criteria. Such information, therefore, may include any suitable combination of the donor identity and contact information such as the donor's name, address, phone number, and/or email address. Also provided is indicia for donor handwritten input concerning the donor's name, the monetary amount of donation, the desired allocation of funds (if multiple offerings are provided), an indication if the donation is recurring or a one-time donation, and other donor-related information if necessary or desirable.

Like other types of businesses, these charitable organizations are required to account for monetary income and, as such, may be subject to review by taxing authorities such as by the Internal Revenue Service (IRS). For these reasons, individual and aggregate contributions gathered by the organization must be accurately documented when inputted into the accounting system of the organization. Currently, this is conventionally accomplished by individuals who read the donor's information written on the envelope or document, and input this information directly into the accounting software. This requires the donation handlers to read donor information, and then manually input such information into the appropriate fields of the accounting software using a conventional keyboard. As is easy to discern, most charitable organizations must employ individuals to sort through the volume of donor provided contributions and information and record the various donation amounts and donor identification information correctly.

However, due to the nature of non-profit organizations and the often limited funds available to employ individuals such as an accountant, many charitable institutions rely on volunteer labor. Using volunteers results in using individuals with good intentions but possibly limited accounting skills and attention spans. Further, using volunteers inherently tends to vary the personnel who perform a task, resulting in a continual flow of new volunteers who are unfamiliar with the task and accounting requirements, inherently increasing errors.

As a result, while they may be kindhearted and have good intentions, such volunteer individuals sorting and recording the donor-provided hand written documents will generally lack proficiency in record keeping requirements for taxing authorities, as well as the general accounting of the charitable organization. Such can result in ongoing input errors which will compound the accounting problem for the charitable organization, as wells as the individual donors thereto. In addition, although many accounting related tools and software applications are known in the art for tracking monies received by charitable institutions, because a large percentage of donors tend to write their identification and donation information on individual envelopes and pages, each must be read, discerned, and manually inputted into software programs by the potentially unskilled volunteer by hand. In addition to the extremely time consuming nature of such an ongoing task, each such read and discerned envelope or page has the potential for input errors by the person reading it.

As a result, inaccuracies in tracking of individual and aggregate donations, and matching such accurately to donors, can occur. The potential for inaccurate tracking of donations and donors increases for charitable organizations with higher memberships or during periods of high individual donations. Such inaccuracy is detrimental to the organization in the event of a financial audit, and can irritate individual donors to the point where donations become fewer or cease.

In some cases, if the IRS or another taxing entity decides that the organization has failed to comply with applicable tax laws and regulations concerning charitable donations, the IRS or taxing agency may impose monetary penalties, excise taxes, and, in extreme cases, may revoke the nonprofit organization's tax exemption. Penalties may also be imposed on directors, officers, employees, and others who participated in improper activity through the organization. Further, individual donors are required to provide taxing authorities written and accurate proof of charitable donations for tax purposes. Inaccuracies in reporting donations by the charitable institution can cause severe tax problems for donors.

As a result, there is a continuing and unmet need for a system and method providing a means for increasing efficiency and streamlining the record keeping tasks related to contributions given to an organization. Such a system should preferably provide an application or set of tools employing software adapted at the task of reading, counting, inputting, documenting, tracking, reporting, auditing, storing, and archiving individual contribution information efficiently and with a high degree of accuracy to thereby minimize the possibility of errors and providing positive indication for suspected errors. Further, such a system should provide an equally high degree of accuracy as to donor and donation information, whether used by a volunteer with little or no accounting background, or a certified accountant.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in current prior art and accomplishes the above noted goals through the provision of a financial, accounting, and database interface system and method, and means for employment thereof, in combination with donor-completed donation documents. The system and method herein additionally provides an increase in the efficiency and a streamlining of the record keeping tasks related to contributions given to an organization. Further, the system and method allow for a high degree of accuracy in donor tracking and donor matching to donations, even where operated by volunteers with little or no computer or accounting training.

In accordance with a particularly preferred mode, the apparatus and method herein includes a means for optically scanning donation documents submitted and filled-in by donors. Additionally, employing interpretation means for both pre-printed and donor handwritten indicia from envelopes and pages of various sizes is accomplished with limited need for volunteer human reading thereof. Consequently, respective information related to individual monetary contributions from individual donors, scanned and interpreted by software adapted to the task, can be interfaced with accounting software means accurately by communication of interpreted donor and donation information for input into the correct fields or accounts of the accounting software. This is accomplished with limited need for volunteers to read, discern, and type or otherwise input the donor and donation information, and eliminates errors due to incorrect typing input, incorrect reading, or incorrect fund account input by volunteers.

The system, method, and means for application of the invention herein is carried out through the employment of a computer or other suitable microprocessor-enabled device such as a smart phone, a tablet computer, or the like, employing optical scanning hardware and software adapted to the task of carrying out the various functions and features of the invention to be described below. In one mode, a graphic displayed user-interface, in the form of an interface window, is displayed on the display screen of the computer or other device of the user. The graphic interface provides a means for viewing, designating, and manipulating the various fields of information gathered from individual donation envelopes or pages, and interfacing each respective field with the proper input window or manner for the software tracking the organization's financial records, as needed. The graphic interface thus allows each organization to view their respective forms and envelopes, and cross reference fields of donor-written information to the proper respective input of the respective accounting software employed by the organization.

So interfaced with the organization's printed forms and donor envelopes, the system allows volunteers with virtually no accounting or computer background to scan donor pages and envelopes and allow the software to communicate donor and donation information. Additionally, the system can optionally scan checks, and credit card, and debit information, and store such information matched to individual donors, as well as cross check the donation amount provided by the donor with the actual donation. Further, in cases of currency or cash donations, the system can provide a feeder and scanner, or otherwise scan the currency placed in the donation envelope or with the donation document, and count it and ascertain the actual cash donation which can be cross-checked with donor provided donation amount information. Any inconsistency can be flagged for review by a person trained to handle such so that accurate information is inputted to the accounting software. The total donation of currency and/or credit card and/or check will be associated with the individual donor for provision of records to the donor.

Still further, for donors who wish to have appropriate tax information documented, but do not wish to identify themselves to persons processing donations, the system and/or organization can provide donor code names, assigned to the respective donor, which the donor may enter into the donor name field instead of the donor's actual name. The true identity of the donors will be ascertained by the software upon reviewing scanned donor name fields containing the assigned donor code names and using an electronic assigned donor name codes database to electronically match the assigned donor code to donor's actual identity.

Also, in a particularly preferred mode of the device, a component configured for scanning documents, counting cash, scanning checks, and confirming and processing credit card donations, can be provided with the software noted herein. The device may have automatic feeders for stacks of currency, and for donation documents such as envelopes or paper sheets. Video displays above the device will provide the users with instructions and ongoing information. In use, cash, checks, and credit card information placed on donation documents are all scanned by the scanning unit and totaled. The total amount of the donation from any credit card information, currency, and checks is then associated with the donor discerned from the scan of the donation document and stored in association with the individual donor for future provision of donation records.

The scanning unit is triggered by the insertion of a donation document into a scanner with a page feeder for digitizing and reading with OCR software. Any credit card donations are discerned by software adapted to recognize such from the digitized images. Concurrently, a currency counter with a feeder may also be enabled by insertion of currency therein. The currency is fed through the currency scanner, counted, and the total associated with the donor is discerned from the scanned donation document. Once totaled, a video display can instruct the user to insert the next donor document, cash, check, and/or a credit card information associated with the donor document and the system repeats.

The scanning unit is preferably fitted with network communications such that it may communicate with a remote credit card or check approval site and software adapted to the task of clearing credit cards and checks. The unit will communicate with the site, gain approval, input the total credit card donation along with any currency or check donations, if additional donation types/methods are included with the credit card donation, and associate the collected funds to the individual donor identified on the donor document.

It is noted and anticipated that those skilled in the art may recognize various means for carrying out the intended functions of the invention, however, without departing from the scope and intent of the invention. As such, the preferred modes of the device described herein are provided merely as a possible example for carrying out the same, and should not be considered limiting in any manner.

Again it is noted that the information gathered and stored as part of this process may be subject to audits by the IRS and other tax agencies. Therefore, accuracy in the entire process, from scan, optical recognition, field matching, and donation verification, during all steps preceding input, to accounting software and archive, is of particular importance. Verification and correction of the information, along with visual indicators for the user which are essential, are provided.

As such, the system herein employing scanning and software adapted at the task, provides a means for interpreting, counting, documenting, tracking, reporting, auditing, storing, archiving, and communicating the donor and donation information to accounting software means efficiently and with a high degree of accuracy to thereby minimize the possibility of errors. In addition, it is particularly preferred that the system and method herein provides a means for positive indication and/or marking for suspected errors, in order to find and correct such errors prior to archiving the information or prior to communicating such information into the accounting software.

In accordance with at least one preferred mode, the pre-printed and/or handwritten data from hard-copy documents, such as envelopes, handouts, invoices, vouchers, flyers, mailers, and pages of various sizes, are scanned into a user organization computer by conventional methods such as a document scanner or the like. The computer or scanning means preferably employs software adapted at the task of Optical Character Recognition (OCR), Intelligent Character Recognition (ICR) techniques and input field identification, or other suitable methods or means for interpreting the data that will allow data and information from hard-copy documents ranging in sizes up to and including legal size to be translated into machine-readable data.

Once the document is scanned and donor input data and fields are scanned via OCR, ICR, or other suitable means for scanning and interpreting the data, software adapted to the task of handwriting recognition and typed or printed character recognition will ascertain the alphanumeric characters placed in the provided fields on the document by the donor. The data discerned in each donor-input field on the document once converted to computer machine-readable data matching the alphanumeric characters discerned in a format conducive to importing the data into the accounting software adopted by the organization for the task of financial record keeping. Such machine employable data, for instance, includes but is not limited to Comma-Separated Values (CSV), ASCII, or other suitable electronic alphanumeric format known in the art. The CSV or similar formatted data, discerned in the identified input fields for respective donors, is then communicated to and employed in software adapted at the task of financial record keeping, and data and information tracking means, and other suitable accounting methods and means. Thus, volunteers need only feed the documents into a scanner and highly accurate donor identification data and amounts are verified then communicated to the software.

It is noted that in this document, the terms “application” or “tool set” are employed to describe any suitable software adapted to the intended tasks of the invention described therein. Currently preferred features of the invention are described that makeup the intended functionality of the adaptive software of the present invention. These features include, however without implying any limitations thereon:
1. Scanning and interpreting donor written information from identified individual fields of contribution documents;
2. Electronic recognition of donor input indicia and text file data formatting of the scanned information from identified document fields;
3. Donation data and donor information verification and correction;
4. Data tracking/auditing to allow auditors to determine not only when contributions were made, but also when the contribution information and money was processed and added to the system;
5. Information management which establishes an administrative account for assigning privileges to all other users;
6. Data storage of both digital images of the scanned pages and the discerned alphanumeric data from respective fields;
7. Reports and printing of various information to both on-screen display and the generation of hard-copy reports for use in audits;
8. Data communication for inputted and archiving by accounting software employed in combination with the system herein.

It is briefly noted that upon reading of this disclosure, those skilled in the art will recognize various means for carrying out these intended features of the invention. As such, it is to be understood that other methods, applications, and systems employing software adapted to the task which are configured to carry out these and other features both disclosed and discerned by those skilled in the art are considered to be within the scope and intent of the present invention, and are anticipated.

With that being said, in accordance with at least one preferred mode, software adapted at the tasks is provided to allow both pre-printed and handwritten information from hard-copy documents, in sizes up to and including legal size (i.e., 8 by 14 inches), to be optically scanned using suitable optical scanner means into a digital format, such as a conventional document scanner, a smartphone, camera, or the like, and employing suitable OCR adapted software configured to recognize printed and handwritten indicia.

Briefly, the selection of the scanner means should be based on efficiency and cost, such as the volume of hard-copy documents that will be scanned during any work session, and the total number of documents from a specific event or date. Given that a balance must be established between the two factors, efficiency and cost, with the best selection being the most cost effective scanning hardware means and software combination, given workload and budget. The scanner means features, without placing limitations thereon, which should be preferably considered include: speed; scanning in color; ease of use; Mean-Time-Between Failures (MTBF); and annual maintenance and upkeep cost.

In at least one preferred mode, the means for optically scanning the documents is provided by a smartphone device having image capturing means, such as a camera, and employing software adapted to the task of the various features described herein.

The software may be in the form of a downloadable application, of which the user can download over a network, such as the Internet. Thus the current system can be carried out through the use of existing smartphone devices without the need to implement costly or additional scanning hardware in the form of a document scanner or the like.

Once the envelope or page is scanned, or electronically photographed, or otherwise rendered to an electronic rendition of the document, suitable scanning software communicating with memory holding the electronic document in one or a combination of the scanner, digital camera, or computer device is employed to discern the alpha numeric characters input by the donor into identified field areas of the digital document and/or the pre printed indicia of the organization, to produce data in an electronic text delimited format, as well as to render an electronic display of the data from, and/or the entire single envelope or page, in an electronic data record capable of being manipulated.

The data from each respective digitized envelope or page is preferably ascertained by donor entry field and segregated into a single text delimited formatted record or other format adapted for communication and input into accounting software. The electronically stored and communicated work from any session would contain a corresponding text delimited formatted record, of each digitized document and each respective identified field of donor input and/or pre printed input, for each respective envelope and/or page scanned during the work session. A work session would be all work performed as noted above by the software adapted at the task, subsequent to launching the software application managing the system herein and starting a work session from menu selection, to ending the work session via menu selection.

Further, it is preferred that the input identified by the optical character recognition software be inputted in the appropriated identified fields in the accounting software, multiple amounts for the same fund to be processed for the same day/date, as it is anticipated that different donors may contribute to the same fund or different funds. This feature shall be included in the on screen display and the applicable reports. Also, the digitized image of the scanned or electronically photographed envelope or page shall be stored in electronic memory and cross referenced in a relational database to make it available during subsequent data change processes and during audit reporting. Therefore, the user or charitable organization is provided with a digital copy stored in electronic memory of the physical hard-copy document should there be a need to verify the scanned and discerned fields of data of saved information.

Additionally, the system provides a means for physically flagging all records which are discerned to potentially have errors at positions adjacent to the discerned mismatches. For example, providing some form of colored shading or other suitable indicia, adjacent to a position on the scanned document, to highlight software-discerned erroneous data in the identified fields in question. Such may occur where the donor has hand written one amount for a donation on the envelope or document in a field provided for such, and the digital scan or digital photograph of the amount placed in an area for an actual donation amount differs from the input amount. Other potential errors may also be flagged, for instance, where the software interpreting the alphanumeric characters in the donor name field discerns alphanumeric characters which do not make sense or do not match the names of donors stored in the relational electronic database of donors.

In such an occurrence, software running on a microprocessor, and adapted for matching the discerned alphanumeric characters from two or more fields which should match, and does not, is employed. Upon discerning a mismatch, the user is preferably provided with a visual cue, imprinted to the donation document close or adjacent to the discerned mismatched fields. Viewing the marking or visual cue, the user will then have the opportunity to manually correct the information by an input to the computer running the system, and clear the flag set for a potential scan-error. This correction can be done immediately, or the scanner may stack contribution documents with discerned errors for later correction.

The software employed to interpret the alphanumeric characters on the digital document is therefore preferably adapted with the capability to use lookup tables and the like to ascertain potential matches to words or numbers which are not discernable and enter its best guess, add, subtract, or modify, as to the correct identity of the character(s) of a discerned field of the digital document. Thereafter, the data discerned will be communicated to the accounting software for entry, or visually flagged in the field or fields of the digital displayable document where the probability of an error in the discerned data of alphanumeric characters exceeds a pre-specified threshold. This feature is particularly preferred in all modes of the system given that the information of the hard-copy documents may have been hand written by the donor, and scanning errors when converting to a machine-readable data may occur which may be easily corrected by a human when keyed to the field of concern by a marking or coloring or the like.

The scanning and interpreting means of the invention are additionally preferably configured to be able to scan conventional bank checks, and use optical character recognition and/or magnetic ink character recognition (MICR) means to decipher the coding at the bottom of the check, in addition to the other pre-printed and handwritten data in identified fields of the digitized rendition of the check. Further, the employment of money counting scanning software which counts both cash and coins may also be employed, since cash donations may be provided by donors. In at least one mode of the invention, this may be provided by a digital photo captured by a smartphone, camera, or other suitable means whereafter software adapted to identify monetary denominations of bills and coins is employed to total the discerned donation amount of cash.

The electronic communicable file produced from the scanning or digital rendering operation is preferably formatted in a machine-readable format similar to CSV (Comma-Separated Values), or other suitable format for input to the accounting software employed in combination herewith, which employs record tracking and numbering system identifier means. Each envelope or page that is scanned or digitally rendered preferably produces a separate record in a text file which is labeled with a sequence number that indicates the order the items are scanned, and would indicate the temporary record tracking number, all of which may be cross referenced for retrieval from memory in a relational database.

It is noted however that those skilled in the art may recognize various suitable means for record tracking and numbering system identification, and are anticipated. Therefore, any customized or known commercially available database tool which carries out the intended task of record tracking and identification, and is capable of providing unique tracking numbers, may be employed and is considered and anticipated within the intended scope of the invention. The unique record tracking and numbering system identifier means will be extremely useful during audits, and will allow auditors to determine not only when contributions were made, but also when the contribution information and money was processed and added to the financial accounting and database system of the present invention.

In at least one preferred mode of the invention, however without implying any limitation thereto, a tracking and numbering system identification means is provided and a tracking number is assigned using a combination of date, work session, and order of import or scanning order. Because it is assumed that the date of the contribution would be scanned as part of the information on the envelope or page, the date referred to as part of the tracking number may be the date the envelope or page was scanned, where year, month, and day would be in the following format: 17 Jul. 2007 would be 20070717, where the year is represented with four digits, the month with two digits, starting with January as 01 and December 12, and the day of the month as two digits, starting with 01 as the first day of the month and sequentially thereafter, 02, 03 , 04, 05, 06, 07, 08, 09, 10, . . . , etc.

Next, in accordance with the current example of the tracking number method, a ‘session’ number will be appended and this is preferably a 6 digit number starting with 000001 and ending 999999. Finally, a ‘scanning order’ will be the third and final part of the record tracking and numbering system identifier means. This number is preferably a 4 digit number starting with 0001 and ending with 9999.

The complete record tracking and numbering system identification means would therefore be a unique 18 digit identifier, where the session date, session number, and scanning order are concatenated to derive this tracking number. For example, a record scanned on Jul. 17, 2007, during the fourth work session on that day, and this record is the 101^{st} record scanned during the 4^{th} work session, the unique identifier would be 200707170000040101. All scanned documents, cash, or other scanned contributions and discerned information may be stored and retrieved by the system using this identifier as a common cross reference in a relational database.

Although the above example provides a preferred tracking and numbering system identification means, this scheme, or other similar scheme deemed suitable for the intended purpose, should provide a unique identifier for the life of the system.

All data must be verified and corrected, as necessary. First, software adapted to the task of reviewing digitized images of donor documents and/or actual donations will provide a positive indication of the accuracy of the information scanned from the discerned fields of the envelope or page, including pre-formatted forms, such as, vouchers and invoices, etc. Secondly, the software adapted to this verification task would compare the discerned amounts from the actual digitized images of donations and donors and digitized input fields from the envelope and ascertain if the donor and amounts match. If an error is discerned, the mismatched fields are identified visually to allow a user to discern the problem easily. Thereafter, the user may make corrections on a per record basis. Further, any such edits, changes, or corrections are preferably tracked along with information on the person making them and stored as a record in electronic memory related to both the digitized donation document and digitized donation, and the results must be available as input for the reporting feature.

As noted, if the scanning software adapted to the task detects a scanning error, the application will preferably provide a positive visual indicator which is user discernable looking at a video display, such as a flashing of the highlighted record, or other suitable visual indication means, in order to catch the user's attention. Additionally, the application should preferably not allow the user to save the record or close the work session until this suspected error is acknowledged and/or properly handled. This could be acceptance of the data by the user without change, and may be done with a dialogue box that provides this option. For example, “To Accept Data Without Change, Click ‘Yes’,” or, “To Change The Data, Click ‘No’,” or additional options can be displayed to the user.

If the user decides to change the data from an identified field, the information shall be presented in a format where the particular organization and donor information is provided as the header (i.e., Organization and Donors Name, Address, Date of Entry, Date of Offering/Contribution, etc.) and the separate fund amounts are listed beneath by Fund Name, Amount, and other suitable titles. Also, the scanned image of the envelope or page shall be provided adjacent to the donor's and particular organization's information in reduced size such that all information for the record under change is viewable on the screen. The user shall be provided with the ability to zoom in on the image of the envelope or page to be able to read the information that is actually on the envelope or page. In addition, when applicable, if a plurality of donations are allocated to many different offerings by a single user, a total dollar amount shall be provided that indicates the sum of the data displayed and will be a ‘displayed total’. The total scanned dollar amount shall be provided and shall not be alterable by the user. This information will be saved and made available as part of the auditing and reporting data.

Once corrections are made, the user shall be provided a positive indication to accept the changes. The changed data with a new total, if the dollar amounts were changed, or the donor's information, if changed, will be stored along with the original data scanned during the scanning process.

All changes and the original scanned data will be changed in a structure such that an audit can easily identify records that were changed after the scanning process. If the dollar amounts are changed, the reason is preferably recorded along with the changed data record. This could be in the form of a graphic interface check box (i.e., a series of check boxes adjacent to each Fund Name and Dollar Amount in the window for changes) providing a means for indicating the reason for correction, for example, ‘Incorrectly Scanned’, ‘Blank Field’, etc. For the donor's data, it is assumed that there is either a name change, address change, telephone number change, or something of that nature.

Further, complete and easily understood audit reports must be available and shall require that all data, both scanned and changed, are saved and archived, and made available for display and reporting.

In accordance with at least one preferred mode, all data, scanned and changed, shall be digitized and stored as an electronic image or record which is available for retrieval as needed for audit reports, which will include on-screen displays and generation of hard-copy reports and production of electronic data files. Therefore, all data, scanned and changed, shall be saved and archived to allow recreation of reports showing what was scanned and/or changed. This text, along with the image of the envelopes and/or pages, will comprise at least some of the data available during an audit.

The scanned image of the envelope or page provides an added measure of data integrity and an online reference that will assist greatly during an audit. Since digital images require a sizable amount of storage space, the ability to remove images may be considered as an option. Since this option would have income tax implications, some security measures must be put in place to avoid inadvertent and/or unauthorized deletion. The management of information may be easily controlled by the establishment of account where privileges are assigned to specific users and a manager/administrator account would be the first account to be established and that manager/administrator user would assign privileges to all other users.

Strict financial tracking is preferably maintained for all monies coming into and going out of funds and/or accounts. All contributions shall be verified during the data input work session. All disbursements in the form of checks and/or vouchers shall be tracked and debited to the correct account and/or fund.

An additional preferred feature of the invention is the use of means for information management. Currently, there are preferably at least two aspects; the controls or limitations that the suitably adapted software places on the data and the users, and the environment established by a manager/administrator type user. The application preferably has default settings, but as part of the initial program load, the manager/administrator user will be guided through step-by-step procedures that will setup the application. An example of a setup procedure, however without implying limitations thereof, includes:
Establishing accounts for all users and an alternate manager that will be designated by the manager/administrator user.
Establishing usernames and passwords for all users including him or herself.
Establishing parameters for managing data scanning, interpretation, change, and saving.
Establishing accounts where the fund dollar amounts are to be distributed. For example, these accounts can be ‘Ministry Budgets’ for a church.
Establishing parameters for saving data for audits and reporting.
Establishing parameters for data modification after the scan-interpret-change/save process.
Establishing parameters for data archiving taking into consideration information needed for financial audits and tax audits.

Data storage of alphanumeric characters, as well as digital images, is yet another particularly preferred feature of the invention. Discerned alphanumeric data from respective fields of the digital images from each work session is preferably stored in a manner consistent with text file formatting described previously. Data can be saved locally on the computer's electronic memory such as a hard-drive, an external drive, and/or through suitable communication for storage to a cloud network drive, or other suitable data storage means. Once saved, after a work session is completed, or periodically auto saved in case of power failure, the data can be retrieved and viewed. In addition, it is preferred that the user cannot make modifications to the saved data. It is assumed that the saved data has met all parameters for the scan-interpret-change-save process and that the totals for the scanned information are accurate, even if some of the data is incorrect. The data for the changed information shall be sanity-checked prior to saving and that information will be included in the saved file.

The manager/admin user preferably establishes parameters for saving the work session data and archiving individual work sessions as noted previously. The application automates the archiving process through the parameters established by the manager/admin user, such as work sessions for the previous month shall be maintained as saved files with a backup file and work sessions for the month prior to the previous month shall be archived on the 15^{th} of the new month. This translates into 2 and ½ months of data where the first month is archived, the second month is saved with a duplicate backup file, and the third month (i.e., current month) is also saved with a duplicate backup file.

For the saved files, the file retrieval performs a comparison on the two files as a part of it's process, where these files cannot be altered after retrieval. For the archive files, the application prompts the user to start the archive process where the application adds the 1^{st} month's data to the archive folder on the computer or network. The application prompts the user to insert a disc, memory stick, or other memory/backup means to create a duplicate copy. The user may choose to temporarily skip this step. The application may provide a reminder to the user of this step as established by the manager/admin user.

The system, method, and means for application herein additionally will support a full range of data reporting means including individual records, work sessions, contributions dates, weekly, monthly (e.g., Check Register(s), Savings Account, Land Account, Funds Report, Selected Paid Items), yearly (e.g., Fund(s), Individual Contributors, Sum Total of all Accounts to Date), financial, tax, and ad hoc.

In another mode, the accounting software employed to store the gathered individual donor contribution information gathered by the system can be synced with a web site, or other medium employing the use of the internet to communicate information, so that individual donors may make contributions via a web site or other internet communicating medium and said contributions will be attributed to the same donor account containing contributions attributed to the donor by the system.

Further as noted, the system may be especially well enabled through a provided multi-functional scanner adapted to capture digital images of currency, checks, and credit card donations, and read and interpret checks and donation documents, and read and process credit card donations. The accounting and discerned error marking would be handled by the multi-functional scanner which would also have a print head for marking discerned problems with donation documents and for printing.

Other specific reporting shall preferably comprise the ability to display a representation of scanned invoices and transfer the appropriate data from the identified field of the digital image to a displayed representation of a check, and print the displayed check information on a hard-copy blank check. Vouchers shall be handled in the same manner as invoices. Data from a voucher shall be transferable to the check displayed representation and that information printed on a blank check form.

With respect to the above description, before explaining at least one preferred embodiment of the herein disclosed invention in more detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods, and systems for carrying out the several purposes of the present disclosed device. It is important, therefore, that the claims be regarded as including such equivalent construction and methodology insofar as they do not depart from the spirit and scope of the present invention.

The objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a view of a preferred flow diagram of the present invention, highlighting the various preferred features of the invention.

FIG. 2 depicts an example of a graphic user interface, in the form of a window which can be displayed on the screen of a computer or other suitably enabled device, showing the input of donor information from a scanned hard-copy document.

FIG. 3 depicts an example of another view of the graphic user interface, in the form of a window which can be displayed on the screen of a computer or other suitably enabled device, showing the correction of the scanned donor's information.

FIG. 4 depicts a multi-functional scanner and network communication device configured to scan and count one or stacks of currency, read and process credit card information, interpret donation documents, read and process checks, and use an onboard microprocessor to associate an aggregate total donation with an individual donor.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

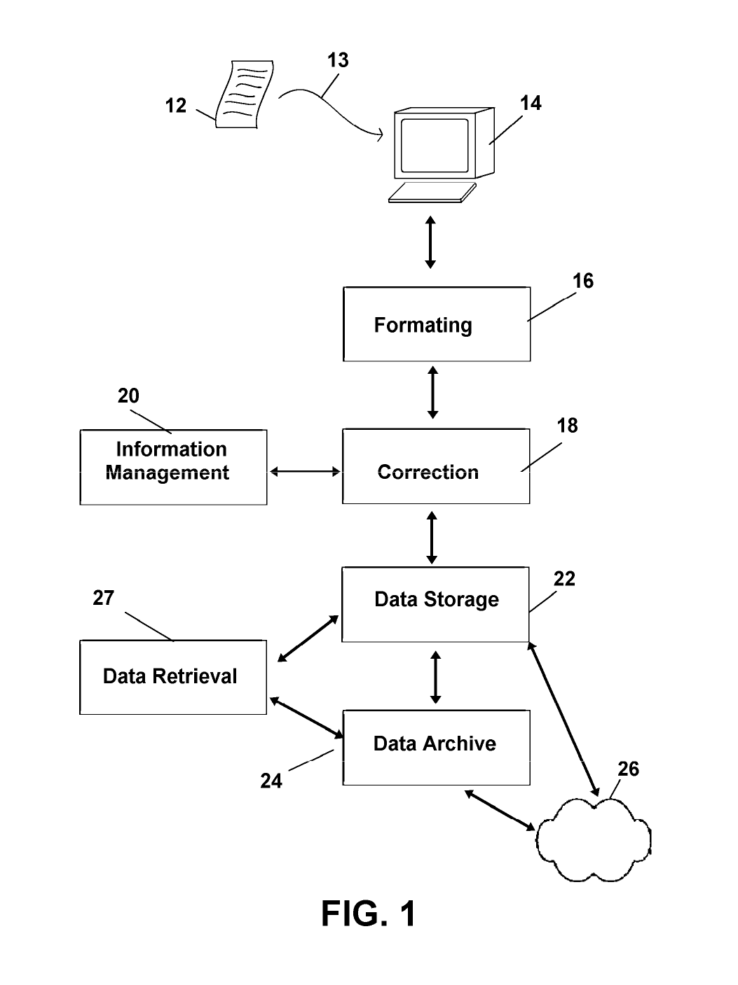

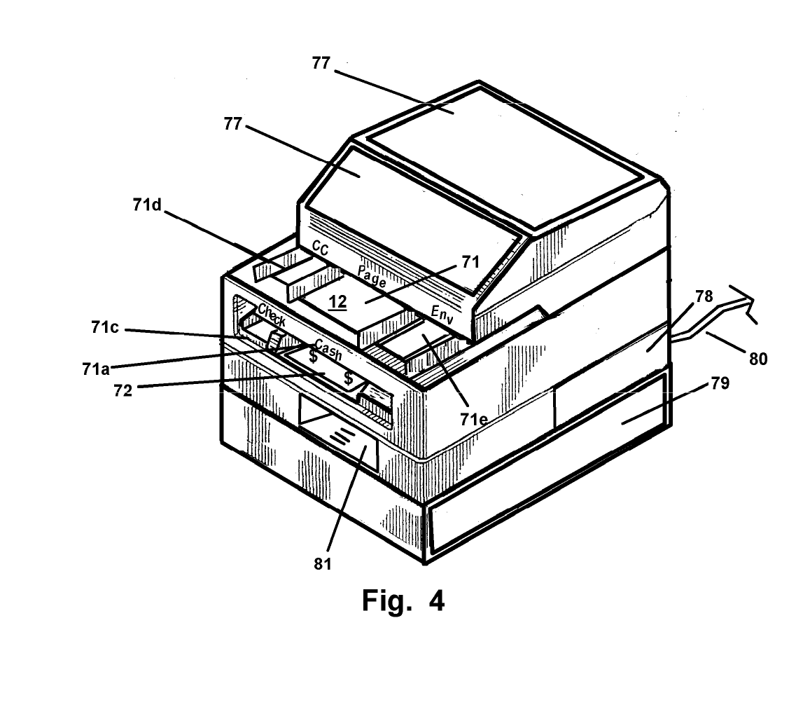

Now referring to drawings in FIGS. 1-4, wherein similar components are identified by like reference numerals, there is seen in FIG. 1 a preferred flow diagram of the invention herein providing a financial, accounting, and database system and method, and means for application thereof, for increasing efficiency and streamlining the record keeping tasks related to contributions/donations given to an organization.

In accordance with a particularly preferred mode, the system and method herein includes means for generating an electronically stored or digitized image, such as a digital photograph or scanning 13, and interpreting pre-printed and handwritten data, in identified fields located in the digitized image of hard-copy documents 12. Such documents 12 may include envelopes and pages of various size having information located in identified fields, related to monetary contributions, and an electronic microprocessor such as a computer 14 or other suitable device employing software adapted to the task of discerning alphanumeric characters located in identified fields of the digitized document 12 and providing and tracking the information using financial and accounting tools, and managing the information using data management tools 20 and data archive means 24, and a means for retrieving 27 the formatted data as needed.

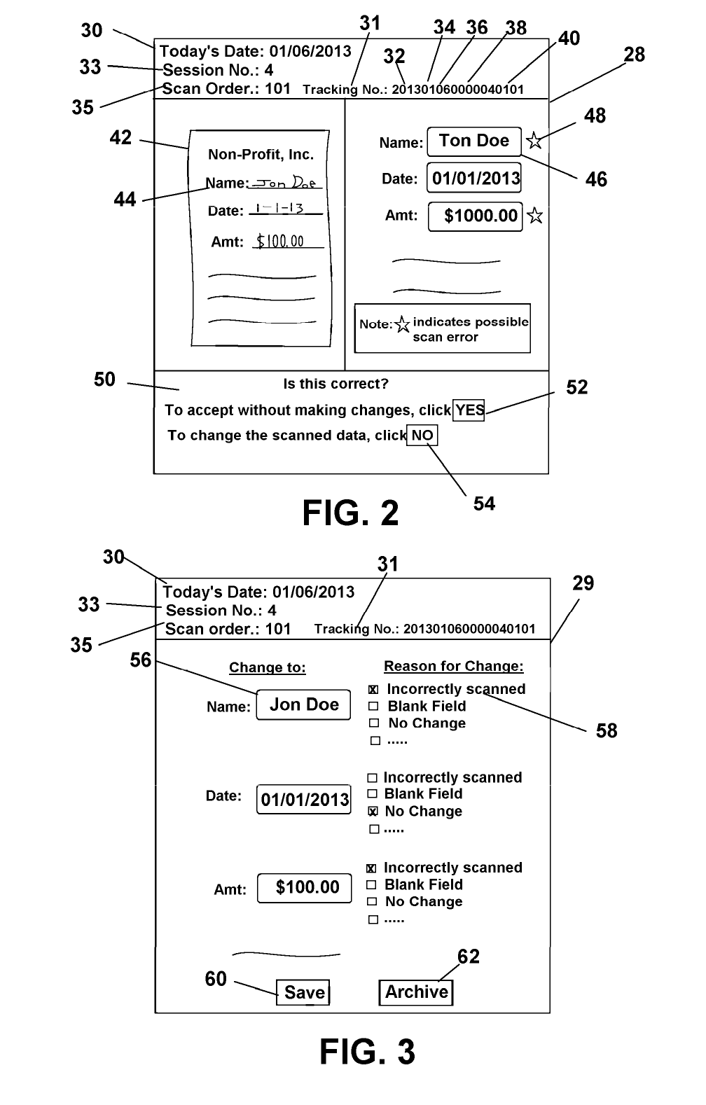

The system, method, and means for application of the invention herein preferably comprises the employment of a computer 14 or other suitable micro processing device such as a smartphone, or the like, employing the necessary hardware to run software adapted to the task of carrying out the various functions and features of the device to be described herein. A user interface, in the form of a graphic interface window 28, 29 (FIG. 2 and FIG. 3 respectively), displayed on the display screen of the computer 14 or other device, provides a means for viewing and identifying fields for discerning the input indicia, and manipulating the various information gathered for the organization's financial records as needed therefore.

In at least one preferred mode, the means for optically scanning 13 the documents 12 is provided by a smartphone device having image capturing means, such as a camera, and employing software adapted to the task of the various features described herein. The software may be in the form of a downloadable application, which the user can download over a network, such as the Internet. Thus the current system and method can be carried out through the use of existing smartphone devices without the need to implement costly or additional scanning hardware in the form of a bulky document scanner or the like, or through the use of a conventional desktop or laptop computer. This mode may be an attractive option since many volunteer laborers may already employ smartphones in their everyday lives and are therefore accustomed to employing the various features of the device, such as capturing images, inputting data, and the like.

The computer 14 and digital document rendering device, such as the scanning means 13, preferably produces a digitized image useable by software adapted at the task of Optical Character Recognition (OCR), Intelligent Character Recognition (ICR) techniques or other suitable method or means for interpreting the scanned data that will allow data and information from identified fields of digitized hard-copy documents 12 ranging in sizes up to and including legal size to be translated into machine-readable data. Once the data is identified in defined fields of the digital rendition of the document, software adapted to discerning alphanumeric characters in the indicia of the specific field is employed such as OCR, ICR, or other suitable means to discern alphanumeric characters and stores them in an electronic rendition of machine-readable data. The data, so discerned and stored in electronic memory, will preferably be in a format configured to importing the data into a suitable software application employed in combination herewith for accounting purposes. Such communicable alphanumeric electronic formats include, for instance, delimited text files, such Comma-Separated Values (CSV), ASCII characters, or other suitable format known in the art.

The captured alphanumeric and/or other indicia file formatting 16 preferably produced by software identifying the indicia in identified fields of the digitized rendition of the document from a digital photo or scanning 13 operation is formatted in a machine-readable format such as one similar to CSV (Comma-Separated Values), or other suitable electronic format which employs record tracking and numbering system identifier means. Each envelope or page that is digitally imaged produces a separate record in an electronic text file, which is labeled with a sequence number that indicates the order the items that were scanned and would indicate the temporary record number.

A tracking number 31 shall be assigned using a combination of date 30, work session 33, and order of import or scanning order 35. The tracking number 31 will start with the date 30 the envelope or page was scanned, where year 32, month 34, and day 36 would be in the following format: 6 Jan. 2013 would be 20130106, where the year is represented with four digits, the month with two digits starting with January as 01 and December 12, and the day of the month as two digits starting with 01 as the first day of the month and sequentially thereafter, 02, 03, 04, 05, 06, 07, 08, 09, 10, . . . , etc.

Next, a ‘session’ number 33 will be appended and this is preferably a 6 digit number 38 starting with 000001 and ending 999999. Finally, a ‘scanning order’ 35 will be the third and final part of the record tracking and numbering system identifier means. The record tracking number 31 will be the sequential number assigned to the record in any scanning session. This number is preferably a 4 digit number 40 starting with 0001 and ending with 9999.

The complete record tracking and numbering system identification means would therefore be a unique 18 digit identifier, where the session date 30, session number 33, and scan order 35 are concatenated to derive this unique tracking number 31. For example, a record scanned on Jan. 6, 2013 during the fourth work session on that day and this record is the 101^{st} record scanned during the 4^{th} work session, the tracking number 31 would be 201306010000040101.

It is the intent of the invention to provide a means for verifying and correcting the data 18 in identified fields of digitized documents as necessary. First, employing software adapted to the task of comparing discerned indicia in respective fields of the digitized document with stored information or discerned information such as actual contained donation amounts, will provide a means for positive indication of the accuracy of the information discerned from the fields of the digitized image scanned 46. Secondly, upon discerning an error or mismatch of indicia discerned in a field of the document, the software adapted at the task must allow the user to make corrections on a per record basis by inputting with a keyboard or manual input device such as a mouse. Edits, changes, or corrections are preferably tracked and the results must be available as input for the reporting feature.

If the scanning software adapted to the task detects a mismatch of discerned data in any field, or through a comparison with any other or with previous records of the same donor such as donor name, the software application will preferably provide a positive visual indication 48 in a displayed rendition of the digitized document in order to catch the user's attention. Additionally, the application must not allow the user to save the record or close the work session until this suspected error is acknowledged and properly handled. This could be acceptance of the data by the user without change, and may be done with a dialogue box 50 that provides this option. For example, “To Accept Data Without Change, Click on ‘Yes’” 52 or “To Change The Data, Click on ‘No’” 54 options can be displayed to the user.

If the user decides to change the data inputted to accounting software, the information shall be presented such that all information for the record under change is viewable on a graphic interface window 29 on the screen. The user shall be provided with the ability to zoom in on the image 42 of the envelope or page to be able to read the information 44 that is actually on the envelope or page. In addition when applicable, if a plurality of donations are allocated to many different offers by a single user, a total dollar amount shall be provided that indicates the sum of the data displayed and will be a ‘displayed total’. The total scanned dollar amount shall be provided and shall not be alterable by the user. This information will be saved and made available as part of the auditing and reporting data.

All changes 56 and the original scanned data will be changed in a structure such that an audit can easily identify records that were changed after the scanning process. If the dollar amounts are changed, the reason is preferably recorded along with the changed data record. This could be in the form of a plurality of graphic interface check boxes 58 (i.e., a series of check boxes adjacent to each Fund Name and Dollar Amount in the window for changes) providing a means for indicating the reason for correction, for example ‘Incorrectly Scanned’, ‘Blank Field’, etc. For the donor data, it is assumed that there is either a name change, address change, telephone number change, or something of that nature. Once corrections are made, the user shall be provided a positive indication to save the changes 60.

An additional preferred feature of the invention is the use of means for information management 20. Currently, there are preferably at least two aspects, the controls that the suitably adapted software places on the data and the users, and the environment established by a manager/administrator type user. The application preferably has default settings, but as part of the initial program load, the manager/administrator user will be guided through step-by-step procedures that will setup the application. An example of a setup procedure, however without implying limitations thereof, includes:
Establishing accounts for all users and an alternate manager that will be designated by the manager/administrator user.
Establishing usernames and passwords for all users including him or herself.
Establishing parameters for managing data scanning, interpretation, change, and saving.
Establishing accounts where the fund dollar amount are to be distributed. For example, these accounts can be ‘Ministry Budgets’ for a church.
Establishing parameters for saving data for audits and reporting.
Establishing parameters for data modification after the scan-interpret-change/save process.
Establishing parameters for data archiving taking into consideration information needed for financial audits and tax audits.

Data storage 22 is yet another particularly preferred feature of the invention. Data from each work session is preferably stored in a manner consistent with text file formatting described previously. Data can be saved locally on the computer's 14 hard-drive, an external drive, through suitable communication to a cloud network drive 26 for archiving 24 the data, or other suitable data storage means. Once saved, after a work session is completed, the data can be retrieved 27 and viewed. In addition, it is preferred that the user cannot make modifications to the saved data. It is assumed that the saved data has met all parameters for the scan-interpret-change-save process and that the totals for the scanned information are accurate, even if some of the data is incorrect. The data for the changed information shall be sanity-checked prior to saving and that information will be included in the saved file.

For the saved files, the file retrieval 27 does not permit files to be altered after retrieval. For the archive files 24, the application may prompt the user to start the archive process where the application adds data to the archive folder on the computer 14 or network 26.

Data retrieval 27 may provide a full range of data reporting means including individual records, work sessions, contributions dates, weekly, monthly (e.g., Check Register(s), Savings Account, Land Account, Funds Report, Selected Paid Items), yearly (e.g., Fund(s), Individual Contributors, Sum Total of all Accounts to Date), financial, tax, and ad hoc. Other specific reporting may employ the ability to display a representation scanned invoice and transfer the appropriate data to a displayed representation of a check, and print the displayed check information on a hard-copy blank check. Vouchers shall be handled in the same manner as invoices. Data from a voucher shall be transferable to the check displayed representation and that information printed on a blank check form.

Finally, in a particularly preferred mode of the system, a scanning component 70 configured with at least one document scanner 71 for scanning and digitizing indicia input upon or written on donation documents 12. Additionally, a currency scanner 71a, counting donated currency or cash 72 and/or determining if any currency is counterfeit, a check scanner 71c for scanning checks and clearing and/or depositing them electronically, and a credit card information scanner and/or reader 71d for scanning and then discerning and confirming credit and/or processing card information with donations, can be provided with the system herein. Additionally, an envelope scanner 71e is preferably provided to scan then OCR characters and indicia on envelopes and feed the envelope to an internal printer 81, for printing and/or for marking the envelope in positions where indicia is not matching or readable to allow a human to review the marked indicia.

The document scanner 71 may also be employed for both cash 72 and documents 12, and the other scanning and image digitizing, but preferably a separate scanning and digitizing component is provided which is configured for that purpose. For instance, in addition to the specialized envelope scanner 71e noted above, the currency scanner and counter 71a would have a bill feeder to feed each bill, and software configured to recognize the value or amount of each bill and count the individual bills of cash 72.

In use, a user can empty a donation envelope of contents, and feed the contents to the appropriate scanner 71, run the envelope through the envelope scanner 71e, and the insertion therein can act as a trigger to the system for initiating a review of the contents of sequential donations in sequentially inserted envelopes. This insertion tells the system a new donation has been started for totaling of the various types of scanned donations inserted along with the envelope.

Upon finishing a cash 72 scan, the currency can be moved internally by the feeder to a safe or strongbox 79, where it may be stored until removed by authorized personnel. From the digitized cash 72 images, the credit card information, the donation documents 12 inserted such as the envelope inserted, and any checks inserted, or credit card information, a total aggregate contribution for each donor associated with an envelope triggering the scanning can be ascertained by software and associated with the donor associated with the envelope and then stored in electronic memory in association with that individual donor for future provision of donation records, and addition of future donations.

Once all documents associated with an envelope are totaled, instructions on the video display 77 can instruct the user to insert the next envelope, with donor document, cash, check, and/or credit card information associated with the donor discerned by scanning the donation documents, and the system repeats.

The scanning unit is preferably fitted with network communications 80 such that it may employ onboard network communications devices to communicate with a remote credit card approval site, and/or bank check clearance site and/or direct deposit, and software adapted to the task of clearing credit cards and/or checks, will communicate with the site, gain approval, and input the total credit card or check donation along with the total of any cash or donations, to the electronic file associated with the individual donor identified by the scan of the donor document 12.

This invention has other applications, potentially, and one skilled in the art could discover these. The explication of the features of this invention does not limit the claims of this application.

It is additionally noted and anticipated that although the device is shown in its most simple form, various components and aspects of the system and method may be differently configured or slightly modified when forming the invention herein. As such, those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A system employing software running upon a computing device having electronic memory, for capturing donation data from indicia positioned upon donor documents tendered with donations, for compilation and entry of said data, directly into accounting software comprising:
means for optically capturing donor documents and electronically converting a respective image of each said donor document, into a respective digital file correlating thereto, for storage in electronic memory;
software configured for electronically reviewing said respective digital files located in computer memory, and discerning a presence of alpha numeric characters which are positioned upon a said donor document correlating to a respective said digital file;
software running upon said computing device for discerning at least a donation amount, and a specific donor tendering said donation amount, using said alpha numeric characters discerned as located upon a respective said donor document;
error detecting software running on said computing device and configured for electronically examining said discerned alpha numeric characters, and comparing such to an electronic file of examples of proper said alpha numeric characters, and, determining a presence of any error in said alpha numeric characters discerned, concerning to one or both of said donation amount or said specific donor;
a computer controlled marking component configured for placing a viewable mark upon a said donor document;
said marking component being controlled to place said mark in an error marking position, proximate to a respective position of said alphanumeric characters determined having an error;
an alpha numeric input component operatively engaged with said computing device and operable by a said user subsequent to a viewing said alpha numeric characters adjacent a said error marking position, said input component employable by said user for inputting corrected characters for said alpha numeric characters adjacent a said error marking position; and
software running upon said computing device configured for communicating said alpha numeric characters corrected with said corrected characters as total donation data correlated with an individual said donor, into appropriate categories of financial accounting software, whereby said donor documents are converted into respective digital files and discerning said alpha numeric characters and any discerned errors in said alpha numeric characters which have been marked and corrected manually, prior to a compiling and entry of said total donation data related to a respective said donor, into said financial accounting software.

2. The system of claim 1, additionally comprising:
said computer controlled marking component being a printer, said printer operatively engaged with said computing device to position said mark in a said error marking position.

3. The system of claim 1, additionally comprising:
said computer controlled marking component having a video display for rendering a viewable display depicting a said donor document correlating to a said digital file discerned to have an error in a said alpha numeric character;
video software running on said computer to position said marking upon said video display in a said error marking position proximate to respective alphanumeric characters discerned to be in error; and
said input device being a keypad.

4. The system of claim 2, additionally comprising:
said computer controlled marking component having a video display for rendering a viewable display depicting a said donor document correlating to a said digital file discerned to have an error in a said alpha numeric character;
video software running on said computer to position said marking upon said video display in a said error marking position proximate to respective alphanumeric characters discerned to be in error; and
either or both of said video display or said printer being employable by a said user for generating said marking in said error marking position for said user to ascertain if a correction is necessary; and
said input device being one of a keypad or a mouse with graphic interface on said video display.

4. The system of claim 1, additionally comprising:
said donor documents having preprinted information fields disposed thereon; and
said fields containing handwritten indicia adjacent thereto, whereby said alpha numeric characters includes a mixture of said preprinted information fields and handwriting.

5. The system of claim 2, additionally comprising:
said donor documents having preprinted information fields disposed thereon; and
said fields containing handwritten indicia adjacent thereto, whereby said alpha numeric characters includes a mixture of said preprinted information fields and handwriting.

6. The system of claim 3, additionally comprising:
said donor documents having preprinted information fields disposed thereon; and
said fields containing handwritten indicia adjacent thereto, whereby said alpha numeric characters includes a mixture of said preprinted information fields and handwriting.

7. The system of claim 1 wherein said means for optically capturing donor documents is one of a group of digital capturing components including an electronic scanner, a digital camera and a smart phone.

8. The system of claim 2 wherein said means for optically capturing donor documents is one of a group of digital capturing components including an electronic scanner, a digital camera and a smart phone.

9. The system of claim 3 wherein said means for optically capturing donor documents is one of a group of digital capturing components including an electronic scanner, a digital camera and a smart phone.

10. The system of claim 4 wherein said means for optically capturing donor documents is a multi scanning component comprising:
a page scanner configured for scanning said donor documents to respective digital images;
a currency scanner configured to scan paper currency and generate digital currency images thereof and having software running on said computing device configured to calculate a total currency donation through a review of said currency images;
a credit card information scanner configured to scan preprinted credit card documents and generating a digital credit card donation document, and software running on said computing device configured to discern said alpha numeric characters located on said credit card document and discern, a credit card account number and related information and a credit card donation amount and clearing software running on a computing device configured to electronically communicate over a network with a financial institution for a clearing of said credit card donation amount from said credit card account;
an envelope scanner configured for scanning preprinted donation envelopes and generating a digital envelope image thereof, and software running on a computing device configured to discern said alpha numeric characters therefrom;
a bank check scanner configured for scanning a bank check and generating a digital check file therefrom, and software running on said computing device configured to electronically review said digital check file and ascertain said alpha numeric characters identifying a bank account number, bank routing number, a donor name, and a bank check donation amount, from said alpha numeric characters thereon; and
totaling software running on said computing device, said totaling software configured to generate said total donation data by summing any said currency donation, any said credit card donation, and any said bank check donation.

11. A multi scanning apparatus configured for processing a plurality of differing monetary transactions, comprising:
a page scanner configured for scanning documents and rendering respective digital images thereof;
a currency scanner configured to scan paper currency and generate digital currency images thereof;
a computing device in communication with said scanner having software running thereon configured to calculate a total currency collection, through a review of said currency images;
a credit card information scanner configured to scan documents bearing credit card numbers and generate a digital credit card document;
software running on a said computing device in operative communication with said credit card information scanner and configured to discern a credit card account number and credit card payment amount, using said alpha numeric characters located in said digital credit card document;
clearing software running on a said computing device in communication with said multi canning apparatus and configured to electronically communicate over a network with a financial institution for a clearing of said credit card payment amount from said credit card account;
an envelope scanner configured for generating a digital envelope image thereof and having software running on a computing device configured to discern alpha numeric characters therefrom;
a bank check scanner configured for scanning a bank check and generating a digital check file therefrom and having software running on a said computing device configured to electronically review said digital check file and ascertain said alpha numeric characters identifying a bank account number, bank routing number, from said alpha numeric characters thereon and thereafter electronically clear said digital check over said network for a check payment; and
totaling software running on a said computing device, in communication with said multi scanner, said totaling software configured operatively communicating therewith to generate a total payment by summing any said currency collected, any said credit card payment, and any said bank check payment.
